(19) United States
(12) Patent Application Publication
(10) Pub. No.: US 2025/0298490 A1
(43) Pub. Date: Sep. 25, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM BUSINESS INNOVATION CORP., Tokyo (JP)

(72) Inventors: Naoto YAMASAKI, Kanagawa (JP); Bo Liu, Kanagawa (JP); Naoya Ueda, Kanagawa (JP); Kimihiko Sasaki, Kanagawa (JP)

(73) Assignee: FUJIFILM BUSINESS INNOVATION CORP., Tokyo (JP)

(21) Appl. No.: 18/798,159

(22) Filed: Aug. 8, 2024

(30) Foreign Application Priority Data
Mar. 19, 2024 (JP) 2024-043674

(51) Int. Cl. G06F 3/04817; G06F 3/0482; G06F 3/0484

(52) U.S. Cl. CPC G06F 3/04817; G06F 3/0482; G06F 3/0484

(57) ABSTRACT

An information processing system includes one or more processors configured to: display a workflow in which icons indicating processes are arranged; and display plural icons continuously arranged in the workflow by dividing the icons into groups of individual categories of the processes.

### CROSS-REFERENCE TO RELATED APPLICATIONS

This application is based on and claims priority under 35 USC 119 from Japanese Patent Application No. 2024-043674 filed Mar. 19, 2024.

### BACKGROUND

### (i) Technical Field

The present disclosure relates to an information processing system, a non-transitory computer readable medium storing a program, and an information processing method.

### (ii) Related Art

Japanese Unexamined Patent Application Publication No. 2008-112393 discloses a technology related to an information processing apparatus that performs a print process, an information processing method, an information processing system, and a program for performing the information processing method. In this related art, a workflow is represented by a visually understandable diagram even if processes in different systems are mixed together. Grouped sub-workflows are exported. The sub-workflows are imported as sub-workflows in a different system. The connectivity of the imported sub-workflows is checked on a group basis. The group structure is represented by an inclusion relation of rectangular areas in multiple layers, and is editable in the multilayer representation.

### SUMMARY

Aspects of non-limiting embodiments of the present disclosure relate to reduction of the probability that an unprocessable workflow is created during workflow creation compared with a workflow in which only icons are arranged.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising one or more processors configured to: display a workflow in which icons indicating processes are arranged; and display a plurality of the icons continuously arranged in the workflow by dividing the icons into groups of individual categories of the processes.

### BRIEF DESCRIPTION OF THE DRAWINGS

An exemplary embodiment of the present disclosure will be described in detail based on the following figures, wherein:

FIG. 1 is a block diagram of the hardware configuration of an information processing apparatus;

FIG. 2 illustrates a workflow creation screen displayed on a display;

FIG. 3 illustrates an attribute setting screen for a process icon (watermark);

FIG. 4 illustrates a state in which a group is selected in the workflow creation screen of FIG. 2;

FIG. 5 illustrates group-based editing in the workflow creation screen of FIG. 4;

FIG. 6 illustrates attempt to place a process icon at a position where the placement is prohibited in the workflow creation screen of FIG. 2;

FIG. 7 is a flowchart of an alert display process;

FIG. 8 illustrates a state in which a placeable position is displayed when selecting and replicating a plurality of groups in the workflow creation screen of FIG. 2;

FIG. 9 illustrates a state in which an alert message is displayed when selecting and replicating a plurality of groups in the workflow creation screen of FIG. 2;

FIG. 10 is a flowchart of a replication process;

FIG. 11 illustrates a workflow creation screen displayed on the display in a modification; and

FIG. 12 illustrates a state in which a group icon is placed in the workflow creation screen of FIG. 11.

### DETAILED DESCRIPTION

### Exemplary Embodiment

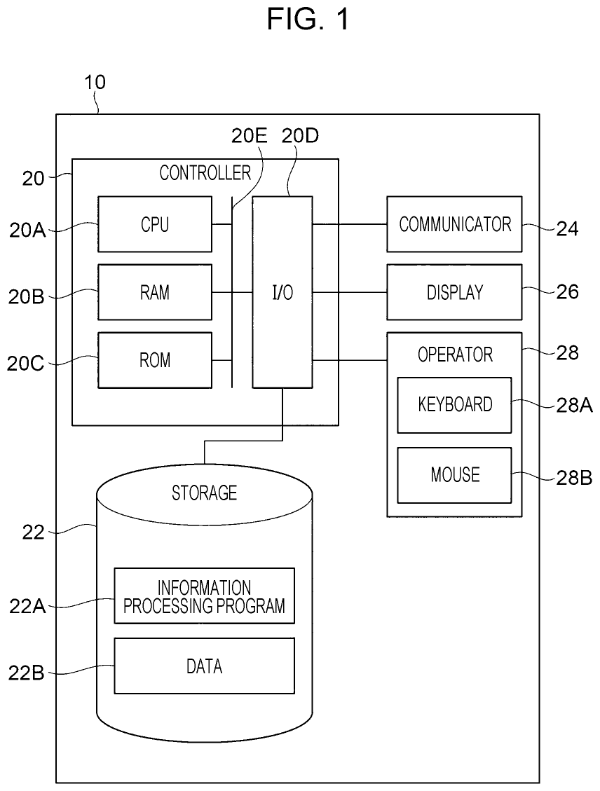

In FIG. 1, an information processing apparatus 10 of this exemplary embodiment that is an example of an information processing system is a computer system that creates a workflow in prepress that is pre-processing prior to printing. A general-purpose computer such as a server computer or a personal computer is applied to the information processing apparatus 10.

### Hardware Configuration

FIG. 1 is a block diagram illustrating an example of the electrical hardware configuration of the information processing apparatus 10 that is an example of the information processing system. As illustrated in FIG. 1, the information processing apparatus 10 of this exemplary embodiment includes a controller 20, a storage 22, a communicator 24, a display 26, and an operator 28.

The controller 20 includes a central processing unit (CPU) 20A, a random access memory (RAM) 20B, a read only memory (ROM) 20C, and an input/output interface (I/O) 20D. These components are connected via a bus 20E. The CPU 20A is an example of a processor.

Functional components including the storage 22, the communicator 24, the display 26, and the operator 28 are connected to the I/O 20D. These functional components may communicate with the CPU 20A via the I/O 20D.

The storage 22 is an auxiliary storage device such as a hard disk drive (HDD), a solid state drive (SSD), or a flash memory. The storage 22 stores an information processing program 22A and various types of data 22B for implementing information processing according to this exemplary embodiment.

The CPU 20A performs processes by reading the information processing program 22A from the storage 22 and loading it in the RAM 20B. The information processing program 22A may be stored in the ROM 20C.

The operator 28 includes operation input devices such as a keyboard 28A and a mouse 28B, and receives various instructions from users. The communicator 24 is connected to a network NT such as the Internet, a LAN, or a WAN, and may communicate with external devices via the network NT.

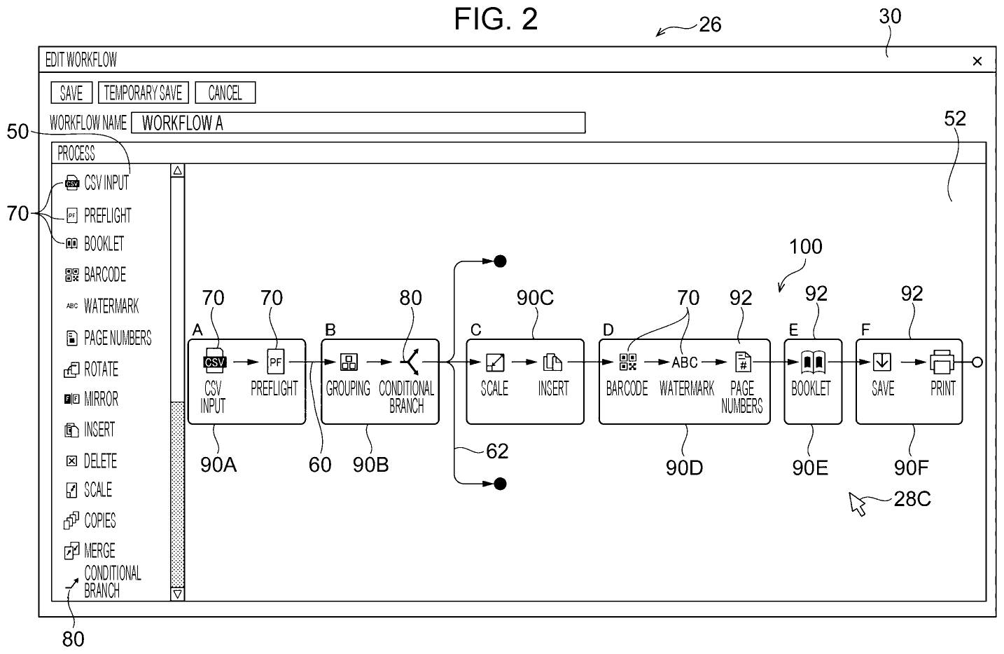

Examples of the display 26 include a liquid crystal display (LCD) (see FIG. 2). The display 26 displays various types of information such as results of processes performed in response to instructions received from users and notifications about the processes. In this exemplary embodiment, the display 26 displays a workflow creation screen 30 for creation of a workflow 100 as illustrated in FIG. 2.

### Workflow Creation

The creation of the workflow 100 (see FIG. 2) using the information processing apparatus 10 illustrated in FIG. 1 is described. In this exemplary embodiment, the “workflow” is a flow of processes in prepress. The “processes” constitute the prepress and are operable independently. Examples of the processes include a booklet creation setting process, a page numbering process, a page deletion process, and a watermarking process. The “workflow creation” is not limited to total creation of a workflow, and includes, for example, reading and editing of a created workflow stored in the storage 22.

FIG. 2 is an example of the workflow creation screen 30 displayed on the display 26 when a user creates a workflow. In this exemplary embodiment, the user is a workflow creator.

In this exemplary embodiment, the left end of the workflow creation screen 30 is a list display field 50 where process icons 70 and a branch icon 80 are displayed. The process icon 70 is an icon indicating a process. The branch icon 80 is an icon indicating a conditional branch. The process icon 70 and the branch icon 80 are examples of icons indicating processes.

To distinguish the process icons 70, each process name in parentheses is prefixed to the reference sign 70. The example of FIG. 2 shows, from the left, a process icon (CSV input) 70, a process icon (preflight) 70, a process icon (grouping) 70, a process icon (scale) 70, a process icon (insert) 70, a process icon (barcode) 70, a process icon (watermark) 70, a process icon (page numbers) 70, a process icon (booklet) 70, a process icon (save) 70, and a process icon (print) 70.

“CSV input” is a process using a CSV file to input data in the CSV file to document data. “Preflight” is a process of checking whether input document data is complete. “Grouping” is a process of grouping a plurality of pieces of document data. “Scale” is a process of increasing or reducing the size of document data. “Insert” is a process of inserting page data such as a blank page into document data. “Barcode” is a process of adding a barcode. “Watermark” is a process of adding a watermark. “Page numbers” is a process of adding page numbers. “Booklet” is a process of arranging a plurality of pages on print paper when creating a printed product of a plurality of pages, such as a brochure or a book. “Save” is a process of saving document data. “Print” is a process of printing. In this exemplary embodiment, the “document data” is PDF data, but is not limitative, and may be, for example, a Word file or a Docucorks (registered trademark) file.

As illustrated in FIG. 2, the right side of the list display field 50 in the workflow creation screen 30 is a workflow creation field 52. The workflow 100 is created when the user arranges, in the workflow creation field 52, the process icons 70 and the branch icon 80 in the list display field 50 by drag and drop using the mouse etc.

A process arrow 60 between the process icons 70 and a branch line 62 indicating a branch are automatically displayed when the process icons 70 and the branch icon 80 are arranged.

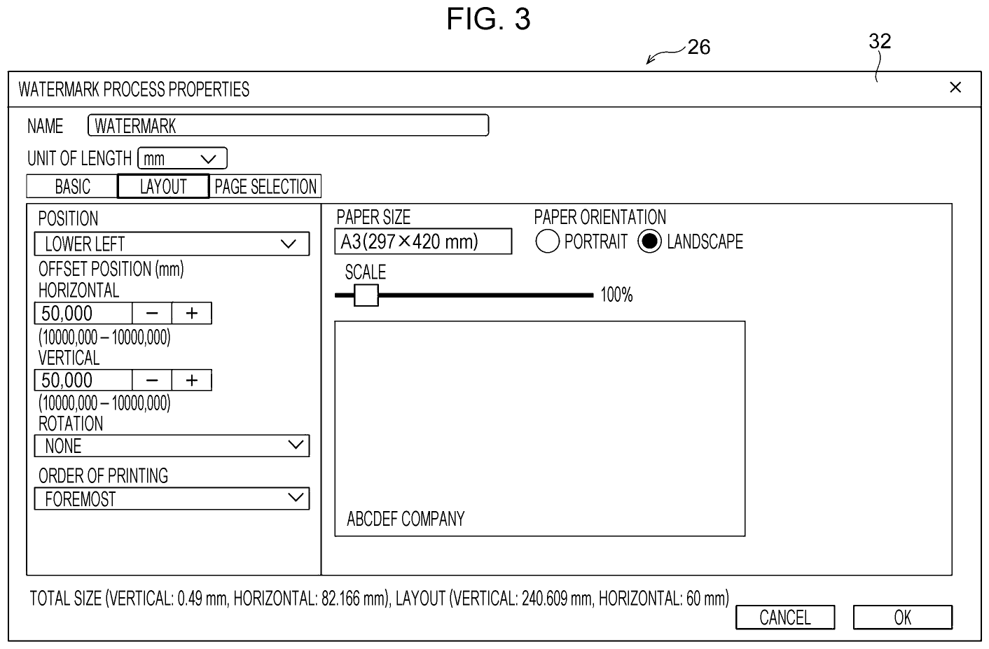

An attribute setting screen 32 illustrated in FIG. 3 is displayed by performing a predetermined operation on the process icon 70 or the branch icon 80, for example, by placing a mouse pointer 28C on the process icon 70 or the branch icon 80 and right-clicking the mouse 28B (see FIG. 1). In the attribute setting screen 32, the user sets attribute items of each process. The “attribute” is a setting that may be changed by a user to change the result of the process, and may be rephrased as “property”.

FIG. 3 illustrates the attribute setting screen 32 for the process icon (watermark) 70. The attribute setting screen 32 is associated with the process indicated by the process icon 70 or the branch icon 80.

### Group Display

Description is made about group display for displaying the process icons 70 and the branch icon 80 in the workflow 100 by grouping them into each process category.

The “category” is a group of similar processes in the prepress. In this exemplary embodiment, the processes are divided into a plurality of categories below.

### Category A: Job Reception Process

Description: process of inputting document data to the system
Process examples: CSV input, preflight.

### Category B: Job-Based Process

Description: process of making settings on a job basis
Process examples: conditional branch, grouping

### Category C: Page-Based Process

Description: process of making settings on a page basis
Process examples: insert blank page, scale

### Category D: Page Addition Process

Description: process of addition to a page
Process examples: barcode, watermark, page numbers

### Category E: Booklet Creation Process

Description: process of setting booklet creation
Process examples: booklet

### Category F: Output Process

Description: process of outputting document data to another system
Process examples: save, print

The workflow 100 is normally created by arranging the process icons 70 and the branch icon 80 in the order of Categories A to F, but the order is not limitative.

In the information processing apparatus 10 of this exemplary embodiment, the process icons 70 and the branch icon 80 are registered in association with the categories.

When the workflow 100 is created by placing the process icons 70 and the branch icon 80 in the workflow creation field 52 illustrated in FIG. 2, the process icons 70 and the branch icon 80 are displayed by being automatically divided into groups 90 of individual categories. In this exemplary embodiment, each group 90 is enclosed by a box 92 and a letter indicating the category is displayed. To distinguish the groups 90, letters such as “A”, “B”, and “C” are suffixed to the reference sign 90 like “group 90A” and “group 90B”. The letters are omitted when the distinction is not needed.

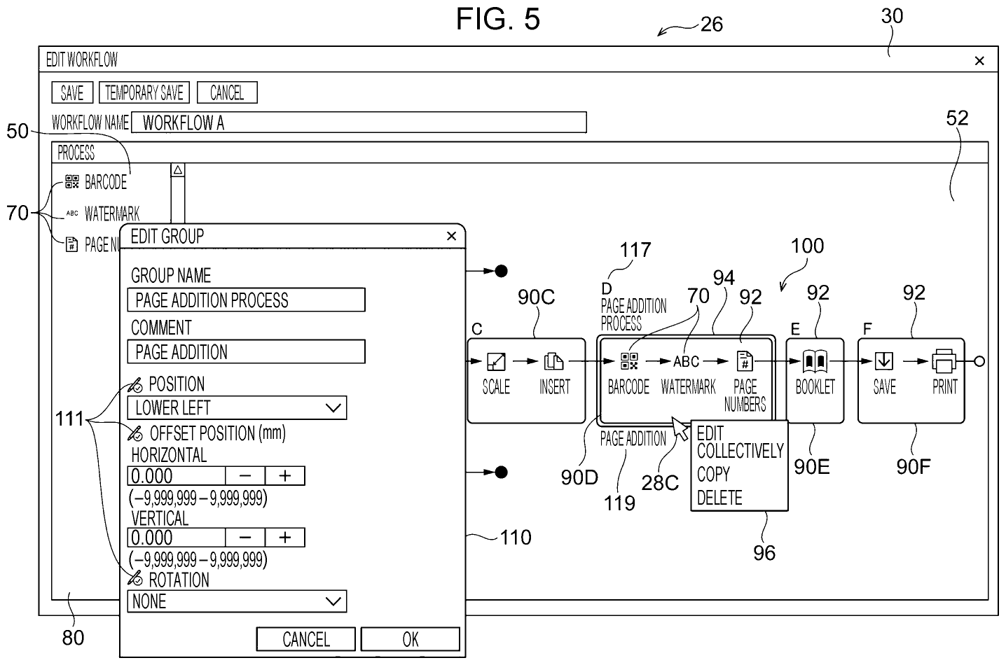

As illustrated in FIG. 5, a group name 117 is displayed when the user performs a predetermined operation, for example, moves the mouse pointer 28C to an area above the box 92 of a group 90 in the workflow 100 and double-clicks the mouse 28B (see FIG. 1), and a comment 119 is displayed when the user moves the mouse pointer 28C to an area below the group 90 and double-clicks the mouse 28B (see FIG. 1).

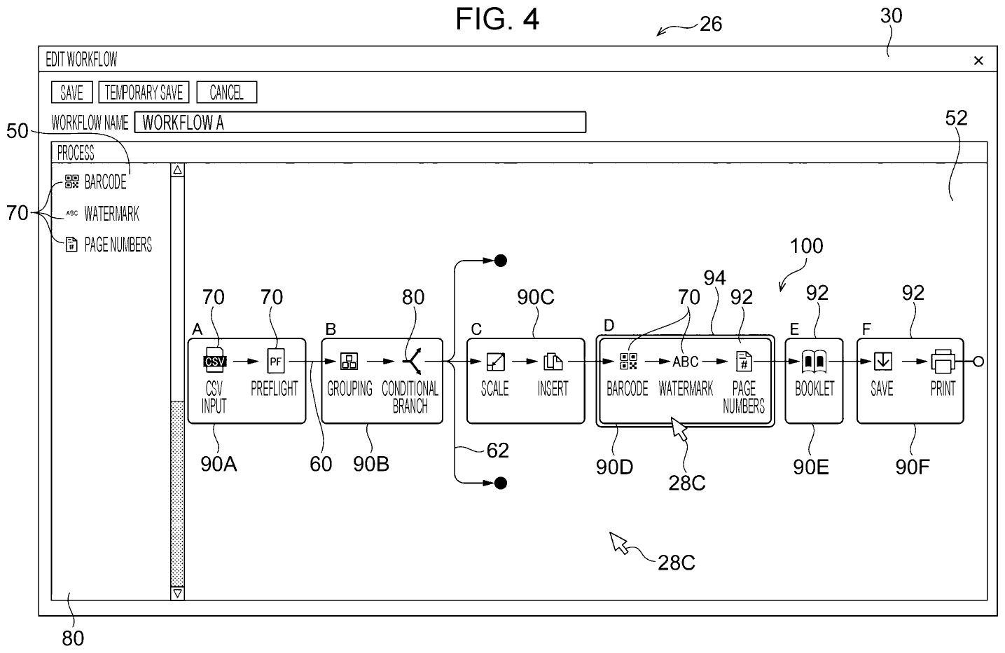

As illustrated in FIG. 4, when the user performs a predetermined operation, for example, moves the mouse pointer 28C into the box 92 and double-clicks the mouse 28B (see FIG. 1), a group 90 is selected and process icons 70 that may be added to the selected group 90, that is, process icons 70 in the category of the group 90, are displayed in the list display field 50. In the example of FIG. 4, the process icons 70 in Category D are displayed in the list display field 50. When the group 90 is selected, the box 92 turns into a double box 94.

When any process icon 70 in the list display field 50 is dragged and dropped onto the process arrow 60 between the process icons 70 in the double box 94, the process icon 70 in Category D is newly added between the process icons 70.

### Group-Based Editing

Group-based editing for collectively editing the entire group 90 is described.

As illustrated in FIG. 5, an edit list 96 is displayed when the user performs a predetermined operation, for example, moves the mouse pointer 28C into a box 92 to select a group 90 and then right-clicks the mouse 28B (see FIG. 1). The edit list 96 in FIG. 5 includes “edit collectively”, “delete”, and “copy”, but is not limitative. When any item in the edit list 96 is selected, a dialog box 110 is displayed.

In FIG. 5, the dialog box 110 is displayed in response to selection of “edit collectively” for collective editing of attributes. In the dialog box 110, settings common to the processes belonging to the group 90 may be edited collectively. FIG. 5 illustrates a display example in which common settings are made for positions and rotation. In the settings, items to be edited collectively and their setting values may be specified. In FIG. 5, a collective editing indication 111 that is a pencil symbol is displayed when an item to be edited collectively is specified.

In the dialog box 110, the group name 117 displayable above the group 90 in the workflow 100 and the comment 119 displayable below the group 90 may be edited as well.

“Delete” in the edit list 96 is used for deleting the entire group 90. “Copy” in the edit list 96 is used for copying the entire group 90 and pasting it at another position.

### Alert Display

Alert display is described.

In the workflow 100 illustrated in FIG. 2, any process may be prohibited downstream of a group 90 in a specific category. For example, any process is prohibited downstream of the group 90F in Category F that is the output process including “print” and “save”.

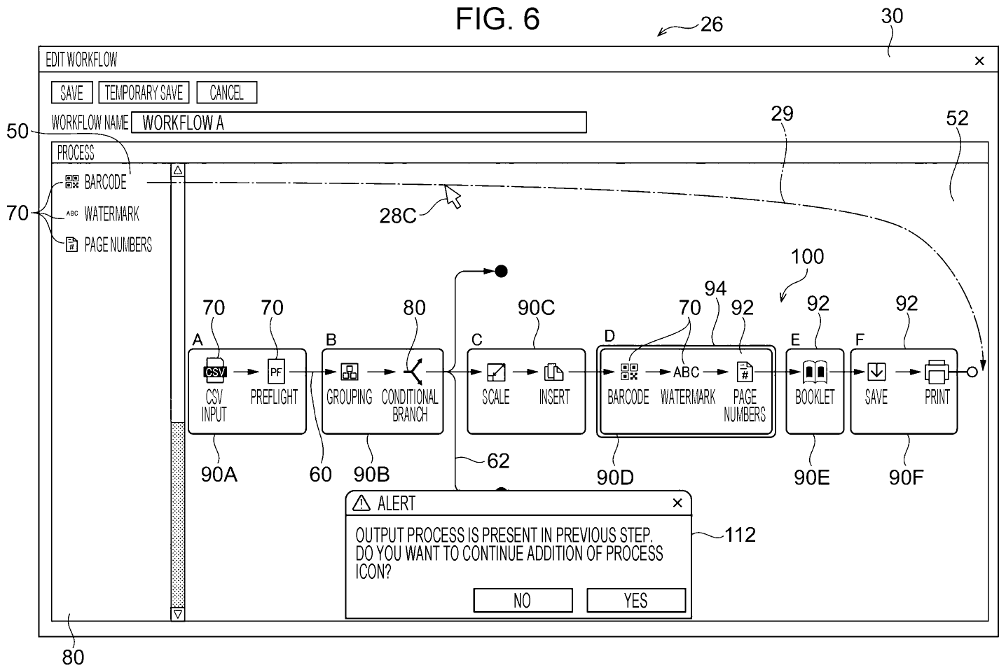

As illustrated in FIG. 6, an alert message 112 is displayed on the display 26 (see FIG. 1) when the user attempts to place a process icon 70 downstream of the group 90F in Category F in the workflow 100. Examples of the alert message 112 include “Output process is present in previous step. Do you want to continue addition of process icon?” A chain line 29 indicates that the user attempts to place a process icon 70 in the list display field 50 downstream of the group 90F in Category F.

In the alert message 112, “YES” or “NO” is selectable. When “NO” is selected, the placement is stopped and the process icon 70 is not placed downstream of the group 90F in Category F. When “YES” is selected, the placement is continued and the process icon 70 is placed downstream of the group 90F in Category F.

The same applies to the case where a group 90 selected by “copy” in the edit list 96 (see FIG. 5) is to be placed downstream of the group 90 in the specific category, in this example, the group 90F in Category F including “print” and “save”.

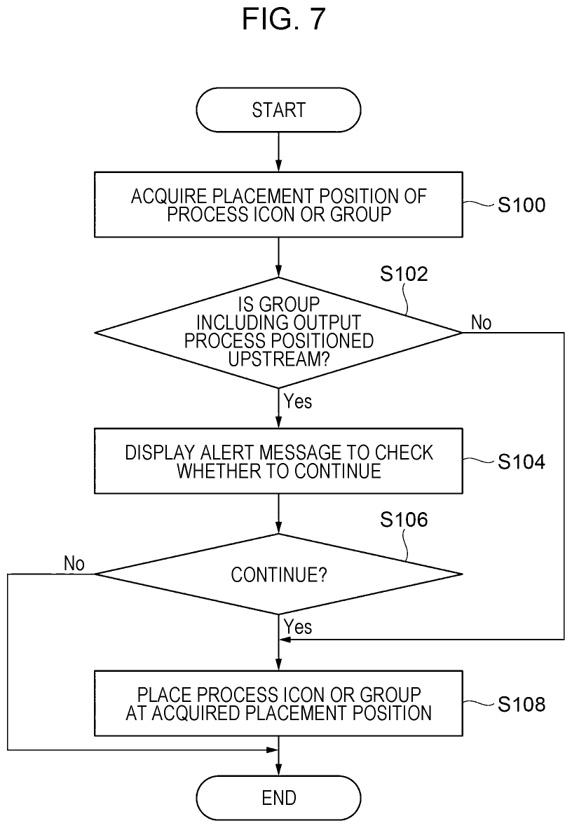

The flow of the alert display process is described with reference to the flowchart of FIG. 7. The process is performed by the CPU 20A (see FIG. 1) reading the program stored in the storage 22 (see FIG. 1), loading the program in the RAM 20B (see FIG. 1), and executing the program.

In Step S100 of FIG. 7, the CPU 20A acquires the placement position of a process icon 70 or a group 90 placed by the user. In Step S102, the CPU 20A checks whether the group 90F in Category F is present upstream of the placement position of the process icon 70 or the group 90.

If the group 90F in Category F is not present in Step S102 (No), the process proceeds to Step S108. In Step S108, the CPU 20A places the process icon 70 or the group 90 at the acquired placement position.

If the group 90F in Category F is present in Step S102 (Yes), the process proceeds to Step S104. In Step S104, the CPU 20A displays an alert to check whether to continue the placement. In Step S106, the CPU 20A checks whether an instruction to continue the placement has been given.

If the placement is to be continued in Step S106 (Yes), the process proceeds to Step S108. The CPU 20A places the process icon 70 or the group 90 at the acquired placement position. If the placement is not to be continued in Step S106 (No), the process is terminated without placing the process icon 70 or the group 90 at the acquired placement position.

### Replication Process

Description is made about a replication process for collectively copying a plurality of groups 90 and pasting them at another position.

In the workflow 100, processes of a plurality of groups 90 may be repeated. For example, the booklet creation process and the barcode placement process are repeated in a plurality of types of processing. In this case, the replication process is used.

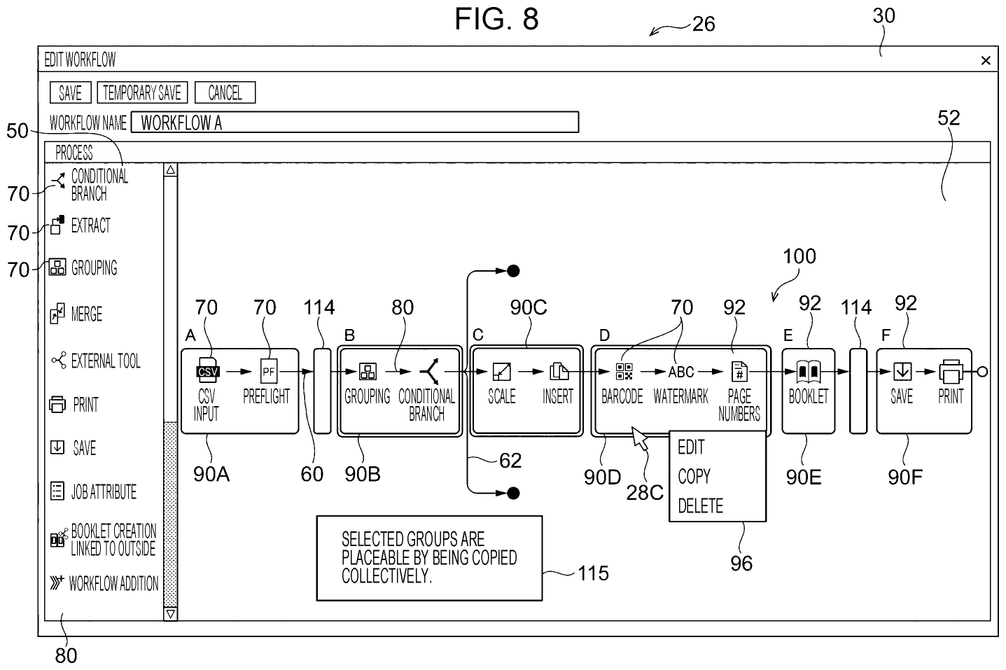

In this exemplary embodiment, as illustrated in FIG. 8, when the user selects a plurality of groups 90 and selects “copy”, a placeability indication 115 is displayed to indicate that the selected groups 90 are placeable by being copied collectively, and a placeable position 114 is displayed to indicate the position where the selected groups 90 are placeable.

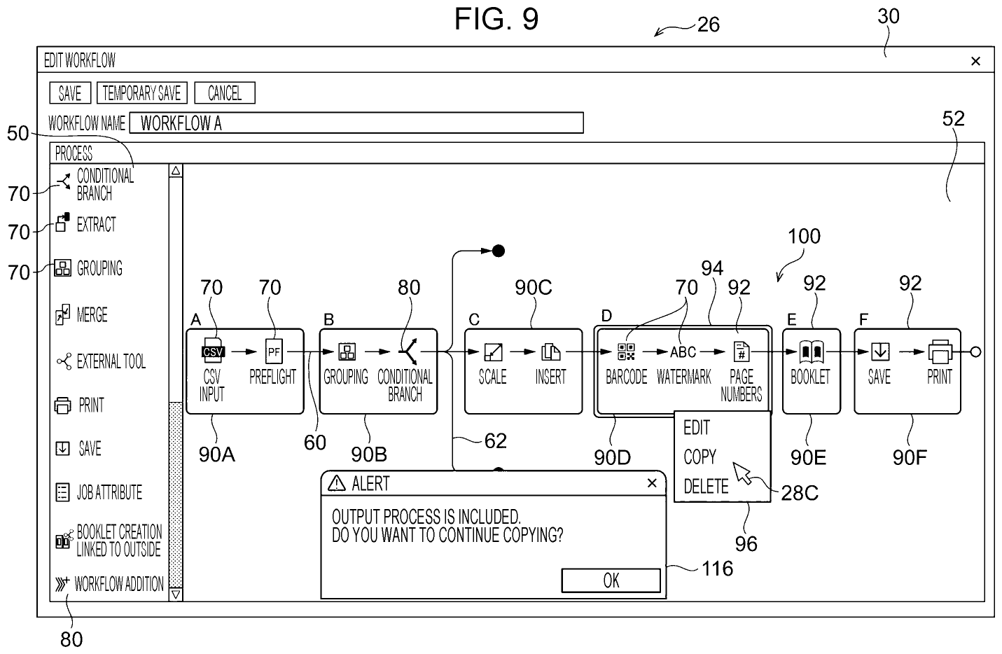

As illustrated in FIG. 9, when the user selects a plurality of groups 90 but the groups 90 are not placeable by being copied collectively, for example, when the selected groups 90 include the group 90F in Category F, an alert message 116 is displayed.

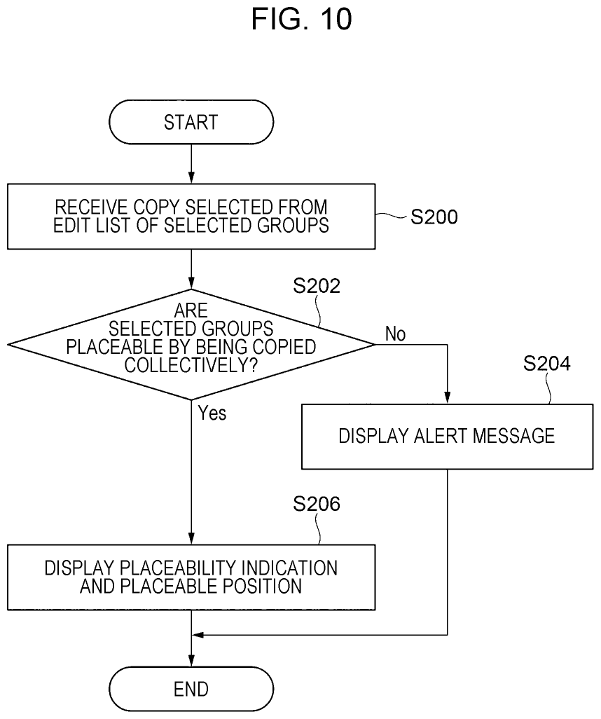

The flow of the replication process is described with reference to the flowchart of FIG. 10. The process is performed by the CPU 20A (see FIG. 1) reading the program stored in the storage 22 (see FIG. 1), loading the program in the RAM 20B (see FIG. 1), and executing the program.

In Step S200 of FIG. 10, the CPU 20A acquires a plurality of groups 90 selected by the user. In Step S202, the CPU 20A checks whether the plurality of groups 90 is placeable by being copied collectively.

If the plurality of groups 90 is placeable by being copied collectively in Step S202 (Yes), the process proceeds to Step S206. In Step S206, the CPU 20A displays the placeability indication 115 and the placeable position 114 (see FIG. 8) on the display 26 (see FIGS. 8 and 9), and terminates the process.

If the plurality of groups 90 is not placeable by being copied collectively in Step S202 (No), the process proceeds to Step S204. In Step S204, the CPU 20A displays the alert message 116 (see FIG. 9), and terminates the process.

### Operations

Operations of this exemplary embodiment are described.

In the workflow 100, the plurality of process icons 70 and the branch icon 80 that are arranged continuously are displayed by being divided into the groups 90 of individual process categories, that is, Categories A to F in this exemplary embodiment.

In this exemplary embodiment, the process icons 70 and the branch icon 80 constituting the group 90 are displayed in the box 92.

The attributes of the processes of the process icons 70 in each group 90 are editable collectively.

In response to selection of a group 90, process icons 70 addable to the group 90 are displayed in the list display field 50.

In response to placement of a process icon 70 or a branch icon 80 downstream of the group 90 in the specific category in the workflow 100, that is, the group 90F in Category F in this exemplary embodiment, the alert message 112 is displayed to check the placement.

If a plurality of selected groups 90 is placeable by being replicated collectively, the placeability indication 115 is displayed to indicate that the plurality of selected groups 90 is replicable collectively.

If a plurality of selected groups 90 is placeable by being replicated collectively, the placeable position 114 is displayed to indicate the position where the plurality of selected groups 90 is placeable.

If the user selects a plurality of groups 90 but the groups 90 are not placeable by being copied collectively, for example, when the selected groups 90 include the group 90F in Category F, the alert message 116 is displayed.

### Modification

A modification of this exemplary embodiment is described.

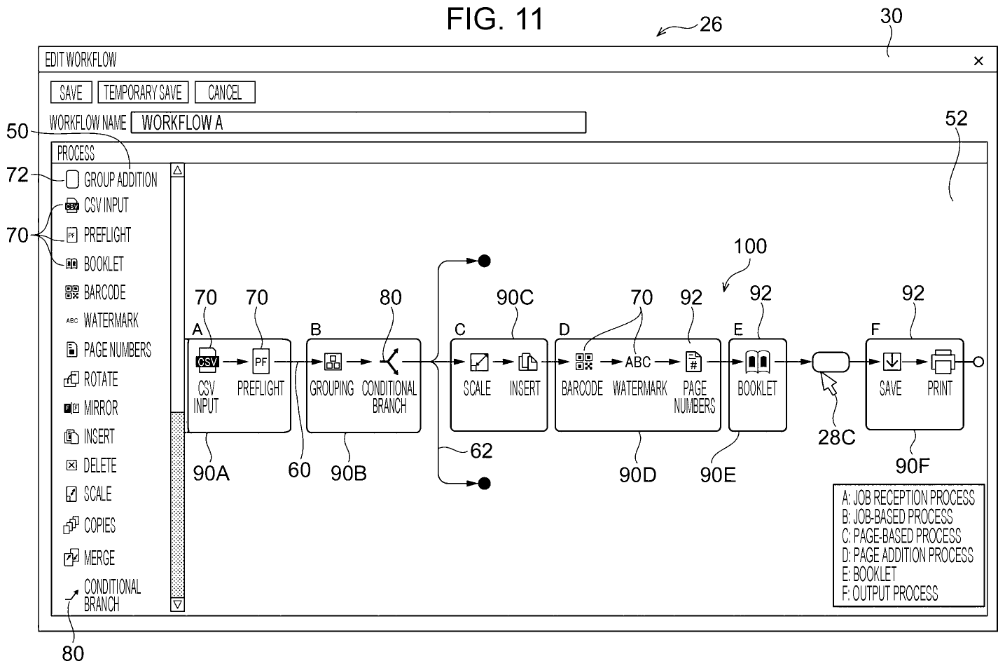

In the modification illustrated in FIG. 11, a group icon 72 is displayed in addition to the process icons 70 and the branch icon 80 in the list display field 50 at the left end of the workflow creation screen 30 on the display 26 during the workflow creation.

The group icon 72 is an icon to be used for placing a group 90 in the workflow 100 that is being created in the workflow creation field 52.

Specifically, the group icon 72 is added to the workflow 100 when the user places, in the workflow creation field 52, the group icon 72 in the list display field 50 by drag and drop using the mouse etc. When the group icon 72 is added to the workflow 100, a category list 98 is displayed and the category of the group 90 to be added is selected from the category list 98.

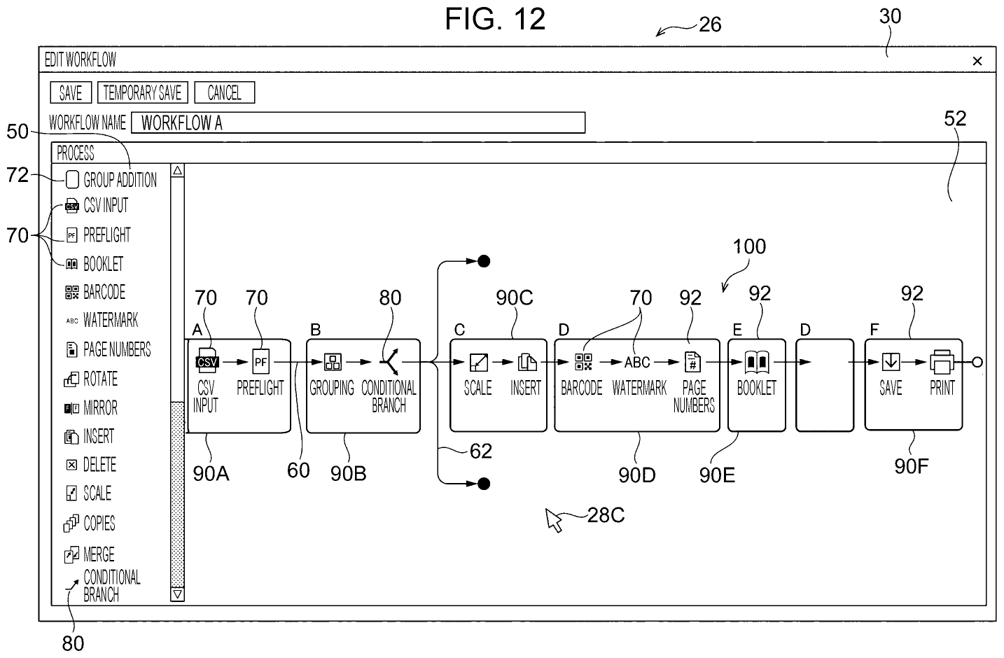

FIG. 12 illustrates the workflow 100 in a case where Category D is selected from the category list 98 (see FIG. 11). The box 92 of the group 90D alone is added to the workflow 100. Then, any process icon 70 in Category D in the list display field 50 is added into the box 92 of the group 90D by drag and drop.

In response to attempt to place the group icon 72 downstream of the group 90F in Category F in the workflow 100, the alert message 112 is displayed as illustrated in FIG. 6. When “NO” is selected in the alert message 112, the placement is stopped and the group icon 72 is not placed downstream of the group 90F in Category F. When “YES” is selected, the placement is continued and the group icon 72 is placed downstream of the group 90F in Category F.

### Operations

Operations of the modification are described.

The group icon 72 is placeable.

In response to attempt to place the group icon 72 downstream of the group 90F in Category F in the workflow 100, the alert message 112 is displayed.

### Others

The exemplary embodiment of the present disclosure is not limited to the above exemplary embodiment.

For example, the information processing apparatus 10 of the above exemplary embodiment is used for creating the workflow 100 in the prepress, but the use of the information processing apparatus 10 is not limitative. The information processing apparatus 10 may be used for creating a workflow in each print process other than the prepress, or may be used for creating a workflow in a process other than the print process, such as post-processing, inspection, or dispatch after printing.

For example, the program for information processing is prestored (preinstalled) in the ROM or the storage in the above exemplary embodiment, but is not limitative. The program may be provided by being recorded in a recording medium such as a compact disk read only memory (CD-ROM), a digital versatile disk read only memory (DVD-ROM), or a universal serial bus (USB) memory. The program may be downloaded from an external device via a network such as the Internet.

For example, the processes that are performed by the CPU 20A reading the program in the above exemplary embodiment may be performed by various processors other than the CPU. Examples of the processors in this case include a programmable logic device (PLD) whose circuit configuration may be changed after manufacturing, such as a field-programmable gate array (FPGA), and a dedicated electric circuit that is a processor having a circuit configuration designed exclusively for performing specific processes, such as an application specific integrated circuit (ASIC).

In the embodiments above, the term “processor” is broad enough to encompass one processor or plural processors in collaboration which are located physically apart from each other but may work cooperatively. The order of operations of the processor is not limited to one described in the embodiments above, and may be changed.

The processes may be performed by a combination of two or more processors of the same type or different types (e.g., a combination of a plurality of FPGAs or a combination of a CPU and an FPGA). More specifically, the hardware structure of each of these various processors is electric circuitry that is a combination of circuit elements such as semiconductor elements.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:
one or more processors configured to:
display a workflow in which icons indicating processes are arranged; and
display a plurality of the icons continuously arranged in the workflow by dividing the icons into groups of individual categories of the processes.
(((2)))

The information processing system according to (((1))), wherein the one or more processors are configured to display the icons constituting each of the groups by enclosing the icons in a box.
(((3)))

The information processing system according to (((1))) or (((2))), wherein attributes of the processes of the icons in each of the groups are editable collectively.
(((4)))

The information processing system according to any one of (((1))) to (((3))), wherein the one or more processors are configured to, in response to selection of one of the groups, display the icons addable to the group.
(((5)))

The information processing system according to any one of (((1))) to (((4))), wherein the one or more processors are configured to, in response to placement of one of the icons downstream of the group in a specific one of the categories in the workflow, display a message to check the placement.
(((6)))

The information processing system according to any one of (((1))) to (((5))), wherein the workflow is creatable using a group icon indicating one of the groups.
(((7)))

The information processing system according to (((6))), wherein the one or more processors are configured to, in response to placement of the group icon downstream of the group in a specific one of the categories in the workflow, display a message to check the placement.
(((8)))

The information processing system according to any one of (((1))) to (((7))), wherein the one or more processors are configured to, if a plurality of the selected groups is placeable by being replicated collectively, display information indicating that the plurality of the selected groups is replicable collectively.
(((9)))

The information processing system according to any one of (((1))) to (((8))), wherein the one or more processors are configured to, if a plurality of the selected groups is placeable by being replicated collectively, display a placeable position where the plurality of the selected groups is placeable collectively.
(((10)))

A program causing a computer to execute a process comprising:
displaying a workflow in which icons indicating processes are arranged; and
displaying a plurality of the icons continuously arranged in the workflow by dividing the icons into groups of individual categories of the processes.

What is claimed is:

1. An information processing system comprising:
one or more processors configured to:
display a workflow in which icons indicating processes are arranged; and
display a plurality of the icons continuously arranged in the workflow by dividing the icons into groups of individual categories of the processes.

2. The information processing system according to claim 1, wherein the one or more processors are configured to display the icons constituting each of the groups by enclosing the icons in a box.

3. The information processing system according to claim 1, wherein attributes of the processes of the icons in each of the groups are editable collectively.

4. The information processing system according to claim 1, wherein the one or more processors are configured to, in response to selection of one of the groups, display the icons addable to the group.

5. The information processing system according to claim 1, wherein the one or more processors are configured to, in response to placement of one of the icons downstream of the group in a specific one of the categories in the workflow, display a message to check the placement.

6. The information processing system according to claim 1, wherein the workflow is creatable using a group icon indicating one of the groups.

7. The information processing system according to claim 6, wherein the one or more processors are configured to, in response to placement of the group icon downstream of the group in a specific one of the categories in the workflow, display a message to check the placement.

8. The information processing system according to claim 1, wherein the one or more processors are configured to, if a plurality of the selected groups is placeable by being replicated collectively, display information indicating that the plurality of the selected groups is replicable collectively.

9. The information processing system according to claim 8, wherein the one or more processors are configured to, if the plurality of the selected groups is placeable by being replicated collectively, display a placeable position where the plurality of the selected groups is placeable collectively.

10. A non-transitory computer readable medium storing a program causing a computer to execute a process comprising:
displaying a workflow in which icons indicating processes are arranged; and
displaying a plurality of the icons continuously arranged in the workflow by dividing the icons into groups of individual categories of the processes.

11. An information processing method comprising:
displaying a workflow in which icons indicating processes are arranged; and
displaying a plurality of the icons continuously arranged in the workflow by dividing the icons into groups of individual categories of the processes.
